(19) United States
(12) Patent Application Publication
(10) Pub. No.: US 2016/0314528 A1
(43) Pub. Date: Oct. 27, 2016

(54) SYSTEM FOR SPEND ANALYSIS DATA TRANSFORMATION FOR LIFE EVENT INFERENCE TRACKING

(71) Applicant: BANK OF AMERICA CORPORATION, Charlotte, NC (US)

(72) Inventors: Robert L. Abbott, Charlotte, NC (US); Michael William Neurohr, Indian Land, SC (US)

(21) Appl. No.: 14/695,252

(22) Filed: Apr. 24, 2015

(51) Int. Cl. G06Q 40/00; G06N 7/00; G06N 99/00; G06Q 30/02; H04L 29/08

(52) U.S. Cl. CPC G06Q 40/00; G06Q 30/0269; H04L 67/306; G06N 99/005; G06N 7/005

(57) ABSTRACT

Embodiments of the invention are directed to a system, method, or computer program product for a distributive network system with specialized data feeds associated with the distributive network for identifying and predicting times of life events within a level of certainty. Utilizing machine learning techniques the likelihood of occurrence of a life event it identified based on a compilation of data points including customer total spend, the magnitude of item or merchant level transactions, and the frequency of item or merchant level transactions. Once a threshold of characteristics is reached, the system identifies with a degree of certainty that an event will occur and a time frame in which it will occur, termed an event horizon. One the event horizon is generated with sufficient evidence from the data points, future actions are positively-biased towards the occurrence of the event.

### BACKGROUND

Merchants and other entities generally provide opportunities to customer based on historical transaction event data points from a customer or the entity. Specifically, in relation to commercial advertisements, offer presentations, and the like, entities target these opportunities based on previous customer relationships or historic trends. Furthermore, with advances in communication technologies, entities have been able to better target customers for opportunities based on historic data. However, it is difficult for entities to predict and present opportunities based on future events that may occur and target those opportunities to the correct customers.

### BRIEF SUMMARY

Embodiments of the present invention address the above needs and/or achieve other advantages by providing apparatuses (e.g., a system, computer program product and/or other devices) and methods for spend analysis data transformation for live event inference tracking. As such, the system identifies and predicts times of life events of an individual in the future within a level of certainty. A life event is a major event in a customer's life that changes his/her status or circumstance financially or otherwise. Life events may include having children, graduating from school, changing careers, purchasing a home, purchasing a vehicle, conducting renovations on a home, or the like.

Utilizing machine learning techniques the likelihood of occurrence of a life event it identified based on a compilation of data points including customer total spend, the magnitude of item or merchant level transactions, and the frequency of item or merchant level transactions. Once a threshold of characteristics is reached, the system identifies with a degree of certainty that an event will occur and a time frame in which it will occur, termed an event horizon. Subsequently after the event horizon is generated with sufficient evidence from the data points, future actions are positively-biased towards the occurrence of the event.

In this way, embodiments of the present invention include systems, methods, and computer-program products for identifying and utilizing total spend data for a customer as a predictive analytic for life event identification, utilizing the life event information to present opportunities and present future actions with a positive-bias towards the predicted event. Total spend is all the products and services a customer purchases within a given time period. The invention identifies the customer transactions and subsequently can identify item level data and merchant level data for the transactions within the time period. From this data the system analyzes, using system programmed learning techniques, patterns or trends associated with the purchases, such as frequencies and magnitudes of combinations of purchases. This data is evaluated against learned models to determine the aggregate probability of a life event actually occurring at a future time. If a threshold was met, the system triggered an identification of the horizon event that being an event that is sufficiently likely to happen in the future based on the threshold being met or exceeded. Once the horizon event is identified, future actions may be positively-biased towards the occurrence of the event.

In some embodiments, the system identifies user total spend. Total spend includes all of the products and/or services purchased by a customer within a pre-determined total spend time period. The customer total spend may first identify the time period and then identify customer transactions that occurred during that time period. The customer transactions are identified by the financial product the customer used for the transaction. As such, if the financial institution associated with the system was also the issuing bank of the credit card the customer used for transactions during the time period, the system can retrieve the transaction data associated with those transactions. In some embodiments, the customer may provide the system receipts or other transaction data associated with the transactions during the total spend time period. Finally, the system may retrieve transaction data from merchants, other financial institutions, or the like.

Based on the retrieved data, the system may identify item level data for the products of the transaction. Item level data includes specific details about the items of the transaction and more specifically, the brand, name, item number, price, manufacturer, or the like associated with the product. Furthermore, the system may identify item level data by retrieving the data or extracting the data off of a receipt, confirmation, or the like associated with the transaction. Finally, the system may receive the item level data from merchant communications. In some embodiments, the system may then compile the item and merchant level transaction data for the customer across the time total spend time period. The system may then group the transactions based on product category and/or merchant category.

Utilizing this data the system identifies magnitude and frequency of transactions for particular categories of products and/or for merchants. Through the accumulation of this data the system compiles the data into a system learned techniques. The system evaluates the data points against learned models to determine the aggregate probability of a life event actually occurring at a future time. If a threshold was met, the system triggered an identification of the horizon event based on the item level transaction data. Once the horizon event is identified, future actions may be positively-biased towards the occurrence of the event.

Embodiments of the invention relate to systems, methods, and computer program products for life event inference tracking, the invention comprising: developing spending profiles for one or more life events based on historic data, wherein developing spending profiles include identifying a frequency and magnitude relative to a time frame for product category and merchant category transactions that provide an predictor that the one or more life events will occur; identifying customer transactions occurring within a time range that utilizes a financial institution product; retrieving, utilizing a distributive network and the specific network data feeds, item level transaction data for products of the transactions occurring within the time range; categorizing the products of the transaction and a merchant associated with the transactions; calculating using a learning application based on the developed spending profiles a probability of one or more potential life events occurring at a future time based on the categorized products and merchants associated with the transactions; triggering, based on a probability value, a point of certainty that a horizon life event associated with the one or more potential life events will occur for the customer, wherein the horizon life event is a specific life event and a specific time range where the horizon life event will occur in the future; distributing throughout an entity via a distributive network to private nodes the horizon life event for the customer; directing positively biased actions to the customer based on the horizon life event; and terminating the positively biased actions upon expiration of the horizon life event time range.

In some embodiments, item level data includes specific information identifying a product including a model number, name, and manufacturer of the product of the transaction.

In some embodiments, the invention further comprising developing and storing for future calculations of horizon life events a spending profile for the horizon life event triggered at the point of certainty that the horizon life event associated with the one or more potential life events will occur for the customer.

In some embodiments, the horizon life event is a specific life event determined to be within a specific time range based on life ontology, wherein the horizon life event is a major event in the customer's life that changes the customer's status or circumstance with respect to financial planning.

In some embodiments, positively biased actions directed to the customer include offers or promotions for products and merchant directly associated with the horizon life event.

In some embodiments, calculating using a learning application based on the developed spending profiles a probability of one or more potential life events occurring at a future time further comprises: identifying leading indicators for the one or more life events, wherein the identified leading indicators are categorized products and merchants that are directly correlated with a life event; and plotting, graphically via vector analysis, one or more categorized products and merchants associated with the transactions along with the identified leading indicators.

In some embodiments, calculating using a learning application further comprises sifting false positives and storing the false positives for subsequent calculations.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a life event inference tracking system environment, in accordance with one embodiment of the present invention

FIG. 2 provides a high level process flow illustrating the spend identification analysis process, in accordance with one embodiment of the present invention;

FIG. 3 provides a process map illustrating identifying products and merchants during a total spend time period, in accordance with one embodiment of the present invention;

FIG. 4 provides a process map illustrating spend analysis or data transformation for life event inference tracking, in accordance with one embodiment of the present invention;

FIG. 5 provides a process map illustrating life event identification and post identification processing, in accordance with one embodiment of the present invention;

FIG. 6a provides a graph illustrating the effect of individual supporting events on life event inference tracking, in accordance with one embodiment of the present invention;

FIG. 6b provides a graph illustrating triggering confidence of a horizon event occurring during life event inference tracking, in accordance with one embodiment of the present invention; and

FIG. 7 provides a graph illustrating the effect of individual supporting events on frequency, magnitude, and time frame for life event inference tracking, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that may are associated with total spend item level affinity identification.

Some portions of this disclosure are written in terms of a financial institution's unique position with respect to customer transactions. As such, a financial institution may be able to utilize its unique position to monitor and identify transactions for products or with merchants that utilize financial institution accounts to complete the transactions.

The embodiments described herein may refer to the initiation and completion of a transaction. Unless specifically limited by the context, a “transaction”, “transaction event” or “point of transaction event” refers to any customer completing or initiating a purchase for a product, service, or the like. The embodiments described herein may refer to an “advertisement.” An advertisement, as used herein may include one or more of a deal, offer, coupon, promotion, incentive, commercial, advertisement, or the like. The advertisement may be for a product, service, merchant, merchant, brand, or the like. Furthermore, the term “product” as used herein may refer to any product, service, good, or the like that may be purchased through a transaction.

Furthermore, the term “electronic receipt” or “e-receipt” as used herein may include any electronic communication between a merchant and a customer, where the communication is associated with a transaction. In this way, e-receipts may include information about the transaction, such as location of purchase, the transaction total, order confirmations, shipping confirmations, item description, SKU data, merchant name, merchant web address, order number, order date, product description, product name, product quantity, product price, product image, hyperlink to the product image on merchant website, sales tax, shipping cost, order total, billing address, shipping company, shipping address, estimated shipping date, estimated delivery date, tracking number, and the like.

The embodiments described herein may refer to the use of a transaction, transaction event or point of transaction event to trigger the steps, functions, routines, or the like described herein. In various embodiments, occurrence of a transaction triggers the sending of information such as offers and the like. Unless specifically limited by the context, a “transaction”, “transaction event” or “point of transaction event” refers to any communication between the customer and the merchant, e.g. financial institution, or other entity monitoring the customer's activities. In some embodiments, for example, a transaction may refer to a purchase of goods or services, a return of goods or services, a payment transaction, a credit transaction, or other interaction involving a customer's bank account. As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a customer's computer or mobile device, a customer accessing their e-wallet or any other interaction involving the customer and/or the customer's device that is detectable by the financial institution. As further examples, a transaction may occur when an entity associated with the customer is alerted via the transaction of the customer's location. A transaction may occur when a customer accesses a building, uses a rewards card, and/or performs an account balance query. A transaction may occur as a customer's mobile device establishes a wireless connection, such as a Wi-Fi connection, with a point-of-sale (or point-of-transaction) terminal. In some embodiments, a transaction may include one or more of the following: purchasing, renting, selling, and/or leasing goods and/or services (e.g., groceries, stamps, tickets, DVDs, vending machine items, and the like); withdrawing cash; making payments to creditors (e.g., paying monthly bills; paying federal, state, and/or local taxes and/or bills; or the like); sending remittances; transferring balances from one account to another account; loading money onto stored value cards (SVCs) and/or prepaid cards; donating to charities; and/or the like.

In some embodiments, the transaction may refer to an event and/or action or group of actions facilitated or performed by a customer's device, such as a customer's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the customer's perspective, the merchant's perspective or both. In some embodiments, the point-of-transaction device refers only to a customer's device, in other embodiments it refers only to a merchant device, and in yet other embodiments, it refers to both a customer device and a merchant device interacting to perform a transaction. For example, in one embodiment, the point-of-transaction device refers to the customer's mobile device configured to communicate with a merchant's point of sale terminal, whereas in other embodiments, the point-of-transaction device refers to the merchant's point of sale terminal configured to communicate with a customer's mobile device, and in yet other embodiments, the point-of-transaction device refers to both the customer's mobile device and the merchant's point of sale terminal configured to communicate with each other to carry out a transaction.

In some embodiments, a point-of-transaction device is or includes an interactive computer terminal that is configured to initiate, perform, complete, and/or facilitate one or more transactions. A point-of-transaction device could be or include any device that a customer may use to perform a transaction with an entity, such as, but not limited to, an ATM, a loyalty device such as a rewards card, loyalty card or other loyalty device, a magnetic-based payment device (e.g., a credit card, debit card, or the like), a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, MP3 device, personal GPS device, or the like), a merchant terminal, a self-service machine (e.g., vending machine, self-checkout machine, or the like), a public and/or business kiosk (e.g., an Internet kiosk, ticketing kiosk, bill pay kiosk, or the like), a gaming device, and/or various combinations of the foregoing.

In some embodiments, a point-of-transaction device is operated in a public place (e.g., on a street corner, at the doorstep of a private residence, in an open market, at a public rest stop, or the like). In other embodiments, the point-of-transaction device is additionally or alternatively operated in a place of business (e.g., in a retail store, post office, banking center, grocery store, factory floor, or the like). In accordance with some embodiments, the point-of-transaction device is not owned by the customer of the point-of-transaction device. Rather, in some embodiments, the point-of-transaction device is owned by a mobile business operator or a point-of-transaction operator (e.g., merchant, vendor, salesperson, or the like). In yet other embodiments, the point-of-transaction device is owned by the financial institution offering the point-of-transaction device providing functionality in accordance with embodiments of the invention described herein.

Embodiments of the invention are directed to a system, method, or computer program product for a distributive network system with specialized data feeds associated with the distributive network and specific triggering events associated with the data feeds for spend analysis data transformation for life event inference tracking. In this way, embodiments of the present invention identify and utilize total spend data for a customer, which includes the products and services a customer purchases within a time period. The invention identifies the customer transactions and subsequently using machine learning system applications; develop patterns in magnitude and frequency of transaction history associated with a product or merchant classification to predict life events of the customer. Once the system identifies a threshold value of sufficient certainty that a life event will occur, the system identifies that life event as a horizon life event and provides a time frame for the event to occur. As such, the system may distributed, via the distributive network to entity computer systems in order to positively-bias future actions directed towards the customer towards the horizon life event.

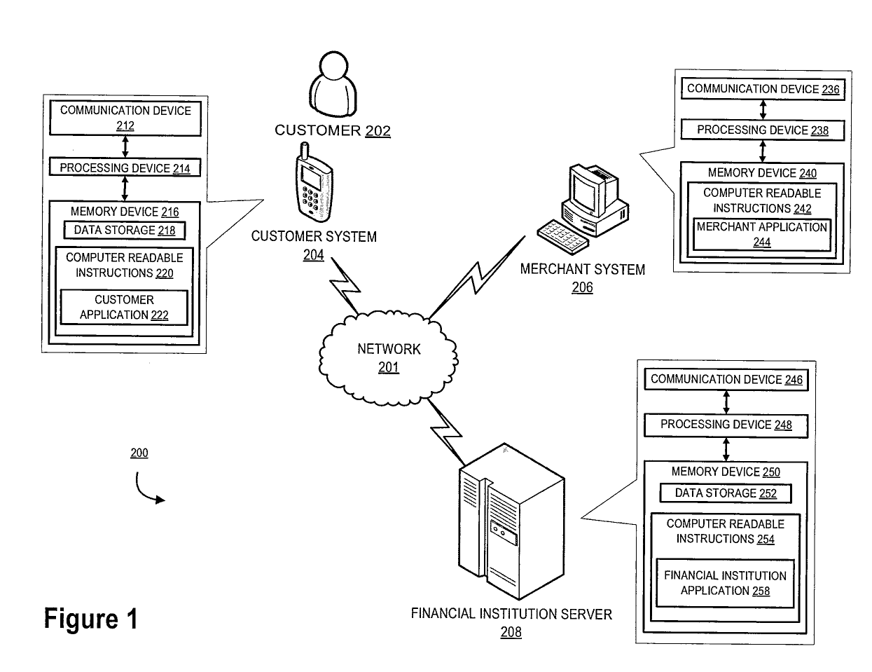

FIG. 1 provides a life event inference tracking system environment 200, in accordance with one embodiment of the present invention. FIG. 1 provides the system environment 200 for which the distributive network system with specialized data feeds associated with the distributive network and specific triggering events associated with the data feeds identify total spend item level affinity for a customer and utilizing the data to predict horizon life events. Subsequently, the system integrates and communicably links actions to customer devices based on the life event identified. The communicable linkage and integration is triggered for termination on a predetermined date where the probability of the life event has ended.

As illustrated in FIG. 1, the financial institution server 208 is operatively coupled, via a network 201 to the customer system 204, and to the merchant system 206. In this way, the financial institution server 208 can send information to and receive information from the customer system 204 and the merchant system 206. FIG. 1 illustrates only one example of an embodiment of a life event inference tracking system environment 200 and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the customer 202 is an individual consumer shopping at one or more online or brink-and-mortar merchant locations within a given time period. The customer 202 may make one or more transactions to purchase a product. In some embodiments, the purchase may be made by the customer 202 using a customer system 204. Furthermore the customer 202 may have one or more life events in the future.

FIG. 1 also illustrates a customer system 204. The customer system 204 generally comprises a communication device 212, a processing device 214, and a memory device 216. The customer system 204 is a computing system that allows a customer 202 to interact with the financial institution. The processing device 214 is operatively coupled to the communication device 212 and the memory device 216. The processing device 214 uses the communication device 212 to communicate with the network 201 and other devices on the network 201, such as, but not limited to the merchant system 206 and the financial institution server 208. As such, the communication device 212 generally comprises a modem, server, or other device for communicating with other devices on the network 201.

The customer system 204 comprises computer-readable instructions 220 and data storage 218 stored in the memory device 216, which in one embodiment includes the computer-readable instructions 220 of a customer application 222. In this way, a customer 202 may receive actions via communicable linkage from one or more devices on the network 201, remotely communicate with the financial institution, authorize and complete a transaction, or complete a transaction using the customer's customer system 204. The customer system 204 may be, for example, a desktop personal computer, a mobile system, such as a cellular phone, smart phone, personal data assistant (PDA), laptop, or the like. Although only a single customer system 204 is depicted in FIG. 1, system environment 200 may contain numerous customer systems 204.

As further illustrated in FIG. 1, the financial institution server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the merchant system 206 and the customer system 204. As such, the communication device 246 generally comprises a modem, server, or other device for communicating with other devices on the network 201.

As further illustrated in FIG. 1, the financial institution server 208 comprises computer-readable instructions 254 stored in the memory device 250, which in one embodiment includes the computer-readable instructions 254 of a financial institution application 258. In some embodiments, the memory device 250 includes data storage 252 for storing data related to the life event inference tracking system environment 200, but not limited to data created and/or used by the financial institution application 258.

In the embodiment illustrated in FIG. 1 and described throughout much of this specification, the financial institution application 258 may identify a customer 202 total spend, calculate using learning applications a probability of one or more potential life events, identify a trigger probability of a horizon life event, push horizon life event data to entity for positively bias of future actions, develop spending profiles for life events, and trigger a return from positively biased actions based on determined time frame of the horizon life event.

In some embodiments, the financial institution application 258 may identify a customer 202 total spend. Total spend includes all of the products and/or services purchased by a customer within a pre-determined total spend time period. In this way, the financial institution application 258 may identify a total spend time period, such as a past day/week/weeks/months/years. Once a total spend time period is determined, the financial institution application 258 may continue by identifying customer transactions during that time period. The customer transactions may be identified based on a customer 202 using one or more financial institution products, such as credit cards, debit cards, checks, or the like, to complete the transaction. In other embodiments, the merchants, customer 202, or other financial institutions may provide the financial institution application 258 or the financial institution application 258 may retrieve the information identifying customer transactions within the time period. The customer transaction data may identify one or more financial transactions of the customer 202 for products, merchants, or services associated with a merchant. The customer transaction data may be identified based on electronic communications between the merchant and customer and/or stock keeping unit (SKU) identification. In some embodiments, the financial institution application 258 may be provided with the customer transaction data from a financial institution. In some embodiments, the financial institution application 258 may determine customer transaction data by receiving or retrieving information from the merchant, social networks, and/or the customer.

Customer transaction data may be utilized to determine item level data that includes item level information about each product or service of a transaction. As such, customer transaction data may be received in the form of SKU level data and/or data from electronic communications between the customer and merchant. SKU level data may be received via the network 201. SKU level data may include specific information about a product purchased by a customer during a customer transaction. This may include codes or the like that identify the specific products of the transaction. The electronic communications data may include one or more of an electronic receipt, invoice, payment, order, report, or other communication identifying a transaction between the customer and merchant. The item level data may be used by the financial institution application 258 to identify one or more categories of products and/or categories of merchants associated with the transactions.

In some embodiments, the financial institution application 258 utilizes machine learning applications to identify potential life events that may occur in the future for a customer 202. As such, the financial institution application 258 may calculate using learning applications a probability of one or more potential life events. In this way, the financial institution application 258 comprise unique patterning applications for the distributive network utilizing data feeds and process flows to systematically identify patterns in customer transactions over the course of the total spend time frame. Patterns may also include one or more transactions for specific products or product categories and the merchants associated with each of those products arranged in logic based on the product, category, and merchant associated with each of the transactions within the time period. These patterns attribute to the machine learning and identification of potential future life events of the customer 202.

In some embodiments, the financial institution application 258 after calculating the probability of one or more potential life events, identifies a trigger probability of a horizon life event. As such, the collection of transaction data is evaluated against the ontology of potential life events, the sum of the probability of all transactions is computed for each known life event relationship. For each transaction and the associated products and merchant of those transactions, the financial institution application 258 determines a contributing probability associated with it. The more there are supporting transactions that support that leading indicator occur, the more the leading indicator is bolstered and subsequently the more confident the life event may occur. At a specific point, such as a p-value being greater than a predetermined percentage, a trigger will be initiated indicating a horizon life event occurring. At that triggering point, it has been determined by the financial institution application 258 that the p-value of a group of transaction data points will lead to a sufficient likelihood of a horizon life event occurring.

In some embodiments, the financial institution application 258 will, ones the horizon life event is identified, push the horizon life event data to the entity for positive biasing of future actions. The financial institution application 258 may push the horizon life event and a time frame for the event. The push may occur via the network 201 and/or a specialized distributive network to unique nodes associated with each unit within the entity.

In some embodiments, the financial institution application 258 may develop spending profiles for life events. In this way, the financial institution application 258 may learn the patters associated with product and merchant categories of transaction data that indicate a specific life event potentially occurring. When the financial institution application 258 identifies these patterns, the financial institution application 258 learns the patterns and stores them as spending profiles for the life event.

Finally, the financial institution application 258 will trigger a return from positively biased actions to the customer based on the horizon life event within the entity to standard actions based on determined time frame of the horizon life event has terminated.

As illustrated in FIG. 1, the merchant system 206 is connected to the financial institution server 208 and is associated with a merchant selling products or services. In this way, while only one merchant system 206 is illustrated in FIG. 1, it is understood that multiple merchant systems may make up the system environment 200. The merchant system 206 generally comprises a communication device 236, a processing device 238, and a memory device 240. The merchant system 206 comprises computer-readable instructions 242 stored in the memory device 240, which in one embodiment includes the computer-readable instructions 242 of a merchant application 244.

In the embodiment illustrated in FIG. 1, the merchant application 244 provides products and services to a customer 202 and is part of one or more customer transactions. In some embodiments, the merchant application 244 may be part of a network associated with the merchant that provides products and services to a customer 202 via online or mobile means. Furthermore, the merchant application 244 may be associate with a brink-and-mortar merchant location. As such, the merchant application 244 may be a part of one or more customer transactions when the customer 202 transacts with the merchant.

In some embodiments, the merchant application 244 may receive requests for item level spend data from the financial institution application 258. In this way the merchant application 244 may communicate with the financial institution application 258 via the network 201 to request total spend data.

It is understood that the servers, systems, and devices described herein illustrate one embodiment of the invention. It is further understood that one or more of the servers, systems, and devices can be combined in other embodiments and still function in the same or similar way as the embodiments described herein.

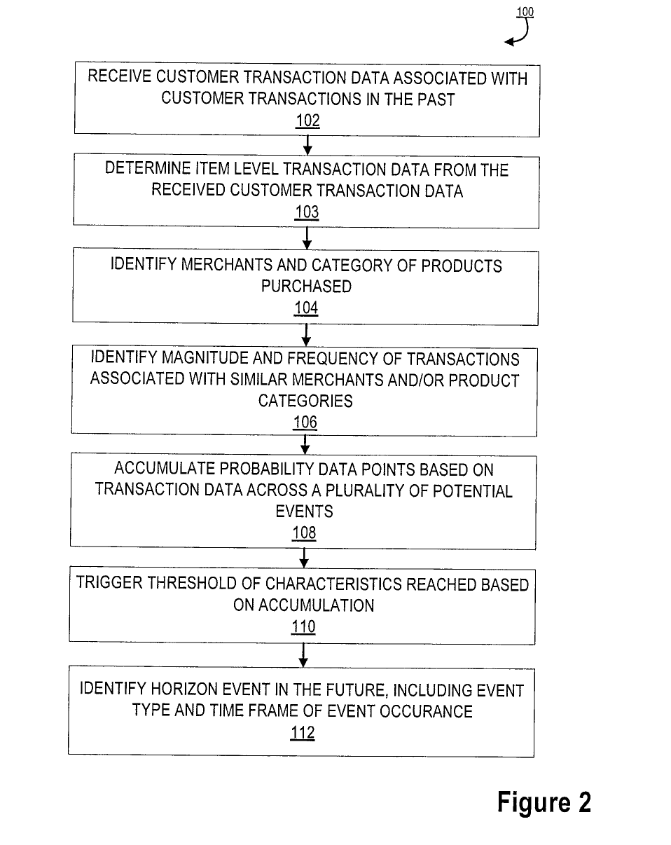

FIG. 2 provides a high level process flow illustrating the spend identification analysis process 100, in accordance with one embodiment of the present invention. As illustrated in block 102, the process is initiated by receiving customer transaction data associated with customer transactions within a time period in the past. The transaction data may be identified based on financial institution product, such as a credit card, or the like being used for the transaction and/or the system may receive the transaction data from the customer, another financial provider, and/or the merchant of the transaction. Transaction data includes data associated with a transaction between a customer and a merchant, including, but not limited to data on a receipt, such as a product price, total price, product identifier, SKU numbers, and/or the like.

Next, as illustrated in block 103, the process continues by determining item level transaction data from the received customer transaction data for that time period. In this way, the system may receive and extract item level data from a SKU associated with the products of the purchase, receive information from a merchant, and/or receive information from a customer about the brand, type, name, price, item number, and the like associated with products of the transaction. In this way, the system may identify specific items of transactions a customer made during a given time frame. As such, identifying specific item information beyond the information a processing financial institution may have knowledge of while processing a transaction for payment. Furthermore, the system also identifies a date and time for each of the transactions.

At this point, as illustrated in block 104, the system may identify merchants and categories of products of the transactions. As such, the system may put each product the customer purchased into a classification. As such, each product and/or each merchant is placed into one or more categories. These categories may be categories of products, such as but not limited to electronics, baby, home goods, home improvement, grocery, clothing, or the like.

Next, as illustrated in block 106, once the system has identified the merchants and product classifications for the customer's transactions, the system may utilize machine learning technology to identify magnitude and frequency of transactions associated with similar merchants and/or product categories. As such, the system groups together and compiles data points associated with frequency and magnitude of categorical purchases to identify life events that may be occurring based on the purchases.

As illustrated in block 108, the process continues by accumulating probability data points based on the transaction data. These probability data points may be utilized to determine one or more potential life events of the customer. The data points are characteristics based on the transaction data patterns, such as magnitude and frequency that are identified as potential characteristic transactions of a potential life event of an individual. As illustrated in block 110, a triggering threshold of characteristics is reached when an accumulation of data points are compiled that provide reasonable certainty to the system that a life event may be occurring.

Finally, as illustrated in block 112, the system may identify one or more horizon events in the future for a customer, which includes an event type and a time frame of event occurrence. Life events may include one or more events that have a significant impact on a customer, these may include a home purchase, home repair, automobile purchase, graduations, retirements, having children, getting married, moving, home selling, or the like.

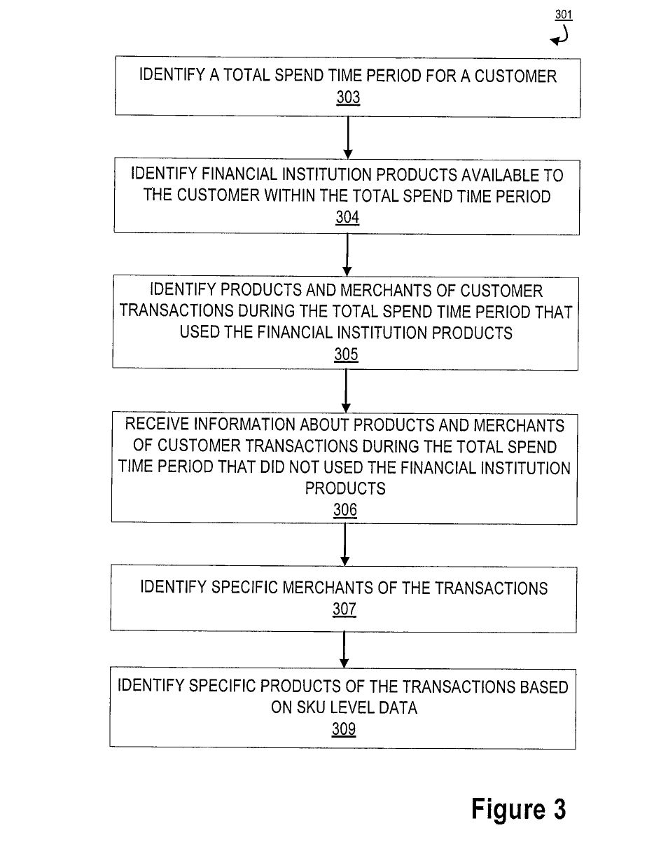

FIG. 3 illustrates a process map for identifying products and merchants during a total spend time period 301, in accordance with one embodiment of the present invention. The process 301 is initiated by identifying a total spend time period for a customer, as illustrated in block 303. This time period may be determined by the system based on a number of transactions for data analysis identified during a time period. The time period may be for days, weeks, months, or years. Furthermore, the time period may be based on customer location. For example, if a customer has recently moved, then the time period may only be for the duration of time at the customer's new location.

Once a total spend time period has been determined, next the system identifies financial institution products available to the customer within that time period, as illustrated in block 304. In this way, the system which is associated with a financial institution may identify the customer, and any financial institution payment products that the customer may have with the financial institution. These payment products may include one or more credit cards, debit card, checking accounts, savings account, or other financial institution provided payment means.

Once these payment products have been identified, the process 301 then identified products and merchants of customer transactions during the total spend time period where the financial institution product was used to complete the transaction, as illustrated in block 305. While specific item level data may not be identified at this step in the process 301, the system is able to determine total transaction cost, some generic data about the products of the transaction, as well as the merchant of the transaction.

Based on identifying the products and merchants of the customer transactions during the total spend time period in block 305, the process 301 continues by receiving or retrieving information about products and merchants of customer transactions during the total spend time period that did not use financial institution products, as illustrated in block 306. In this way, the system may receive information indicating products and merchants of customer transactions. This information may be provided to the system from the merchant, customer, or another financial institution. In this way, the customer could have used any payment device to complete the transaction.

Next, as illustrated in block 307, the system may identify specific merchants of the transactions. Typically, the merchant may be identified based on the generalized data received by the system. The data usually includes a total price, general information about the products purchased, the price of the products, and the name of the merchant associated with the transaction. Finally, as illustrated in block 309 the system may identify specific item level information about the products and merchants of the transaction.

Specific item level transaction data, including a price, product number, product name, brand, or the like, may be derived from online transactions, brick and mortar transactions, repeat customer transactions, or financial institution products used. Furthermore, this information may be provided directly by the customer and/or the merchant.

In some embodiments, online transaction communications may include transaction receipts. Other communications for online transactions may include order confirmations, status updates, shipping updates, or the like. The combination of all of these communications may be considered e-receipts. E-receipts may be any electronic communication from a merchant to a customer based on a transaction. An order confirmation may include detailed information regarding the products or services purchased. For example, in the case of a product, the order confirmation may include stock keeping unit “SKU” code level data, as well as other parameters, such as order number, order date, product description, product name, product quantity, product price, product image, hyperlink to the product image on merchant website, sales tax, shipping cost, order total, billing address, shipping company, shipping address, estimated shipping date, estimated delivery date, tracking number, and the like. The order confirmation also includes information about the merchant, such as name, address, phone number, web address, and the like. The shipment confirmation may be an email, text, voice, or other correspondence from a merchant to a customer indicating the shipment of a product from an online transaction. Status updates may include any type of communication from a merchant that may update the shipping, delivery, order, or stocking of a product of a transaction.

In some embodiments, item level data may be identified based on transactions at a brick and mortar location. In this way, many merchants now also provide e-receipts and other electronic communications to customers shopping at brick and mortar locations. In some embodiments, these communications may include transaction receipts, such as an e-receipt. In other embodiments, these communications may include order confirmations. In general, at the point of sale, the customer may have previously configured or may be asked at the time of sale as to whether he/she wishes to receive an e-receipt. By selecting this option, the merchant will send an electronic communication in the form of an e-receipt to the customer's designated email address.

Here again, the e-receipt will typically include a list of services and/or products purchased with SKU level data, and other parameters, as well as information about the merchant, such as name, address, phone number, store number, web address, and the like.

In some embodiments, item level data may be identified from a repeat customer account. Various merchants now also provide online customer accounts for repeat customers. These online customer accounts may include purchase history information associated with the customer accessible by the customer via ID and passcode entry. Purchase history provides detailed information about services and products purchased by the customer including information found on order confirmations and shipping confirmations for each purchase. Online customer accounts are not limited to online purchases. Many merchants also provide online customer accounts for customers that purchase services and products at brick and mortar locations and then store these transactions in the customer's online account.

In some embodiments, item level data may be identified from financial institution products used during a transaction. In this way, the system may identify one or more transactions that the customer used a financial institution product, such as a credit card, debit card, check, or the like. The system may then be able to identify the transaction based on being the authorizing financial institution of the transaction. As such, the system may receive general information about the transaction and the total price of the transaction. Using this information, the system may request item level data for the merchant and/or customer for the specifically identified transaction. Finally, item level transaction data may be provided directly to the system by the customer and/or the merchant of the transaction.

The system may identify item level transaction data associated with a transaction. This item level transaction data includes product purchase level data from a transaction between the merchant and customer. The system may extract the item level transaction data identified. This extraction may be from a customer account, such as an email account or the like. In other embodiments, the extraction may be from a text, voice, or the like message communicated to the customer.

Regarding email extraction, the system may initially receive authorization for access to the customer's email accounts and retrieves email message headers comprising data fields relative to the email message, such as sender, subject, date/time sent, recipient, and the like. In some embodiments, the system accesses the emails directly. In other embodiments, the system may run search queries of the email database based on known merchant names and/or phrases associated with e-receipt information, such as “receipt,” “order confirmation,” “shipping confirmation,” or the like. Once emails are extracted, further filtering may occur to locate relevant emails. Examples of further filtering may be searches based on known online merchants, third parties known to provide e-receipts, text in the email message subject line that corresponds to known order confirmation subject line text or known shipping confirmation subject line text, such as an email message sent with a subject line containing the text “purchase,” “order,” “ordered,” “shipment,” “shipping,” “shipped,” “invoice,” “confirmed,” “confirmation,” “notification,” “receipt,” “e-receipt,” “e-receipt,” “return,” “pre-order,” “pre-ordered,” “tracking,” “on its way,” “received,” “fulfilled,” “package,” and the like.

In some embodiments, the system may convert the identified item level transaction data from the communication into a structured format for the online banking application to utilize the transaction data extracted.

Financial institutions currently use a data structure conforming to Open Financial Exchange “OFX” specifications for the electronic exchange of financial data between financial institutions, businesses and customers via the Internet. E-receipts, such as electronic order confirmations, shipment confirmation, receipts, and the like typically do not comply to a uniform structure and are generally considered to include data in an “unstructured” format. For example, while one merchant may provide data in an electronic communication to a customer in one format, another merchant may use a completely different format. One merchant may include merchant data at the top of a receipt and another merchant may include such data at the bottom of a receipt. One merchant may list the purchase price for an item on the same line as the description of the item and list the SKU number on the next line, while another merchant may list the data in a completely opposite order. As such, prior to integration of electronic communications relating to customer purchases into online banking, the data from such electronic communications must be parsed into a structured form.

Finally, the identified merchants and specific products may be combined into categories of products and/or merchants that may be associated with a life event. In this way, each product purchase may be put into one or more categories for further analysis to determine life events of a customer.

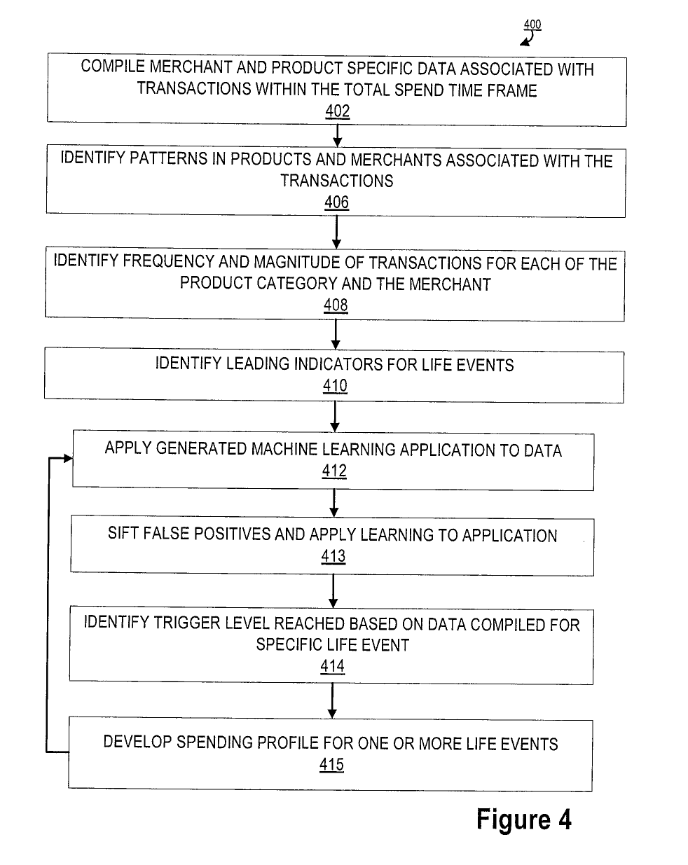

FIG. 4 provides a process map illustrating spend analysis or data transformation for life event inference tracking 400, in accordance with one embodiment of the present invention. As illustrated in block 402, the process 400 is initiated by compiling item level data, such as merchant and product specific data associated with the transactions within the total spend time frame for that customer. Once all the item level data is compiled such that for each transaction the products, prices, brand of products, product numbers, merchant, and merchant location are known by the system. The system may then determine categories of the products and merchants.

As illustrated in block 406, the process 400 continues by identifying patterns in the products and merchants associated with the transactions. In this way, the system may then compile the item and merchant level transaction data for the customer across the time total spend time period. The system may then group the transactions based on product category and/or merchant category. This grouping may provide identifications of patterns with respect to one category or another. Each category, through learned machine technology, may be relevant to a degree to each of one or more life events.

As illustrated in block 408, the process 400 may continue by identifying a frequency and magnitude of the transactions for each of the product and merchant categories. Through the accumulation of transaction data the system compiles the data into a system learned techniques. The system evaluates the data points against learned models to determine the aggregate probability of a life event actually occurring at a future time. The frequency of transactions at merchant or for product categories aids in contributing to the determination of a life event. The frequency includes the number of times within a time period that a customer visited a merchant associated with a merchant category and/or a product associated with a product category. For example, if a customer is identified frequently visiting merchants and purchasing products associated with baby clothing and other baby products, the system may compile the frequency of the transactions to determine a date in the future that the customer may be having a baby. Furthermore, magnitude of purchases may also be analyzed based on category. The magnitude includes the amount or number of purchases made during a time period or one transaction. As such, using the example above, if the system identifies the customer purchasing items from a baby clothing store, but only once and not in a larger quantity, the system may be able to determine that the customer may not be having a baby, but a family member or friend may be having a baby.

Next, as illustrated in block 410, the system may next identify leading indications for life events. Individual events in association with the ontology of life events may indicate a horizon life event with some degree of certainty. Leading indicators include one or more products or merchants associated with a transaction that the system has identified as being significantly linked to a specific life event. These leading indicators may include specialty merchant purchases, for example, home improvement, baby, automotive, or the like. Which tend to support specific life events occurring, such as renovations, having a baby, purchasing a vehicle, or the like.

Once leading indicators are identified, the process 400 continues by applying a generated machine learning application to the transaction data, as illustrated in block 412. Utilizing the transaction data and evaluating it against ontology, the learning application may determine the sum of the probability of supporting events for each known life event relationship. Each event has a contributing probability associated with it, and the more that these supporting events occur the system identifies a bolstering of the probability of a live event occurring.

As illustrated in block 414, the process then identifies a trigger level that is reached based on the data compiled for a specific life event. That triggering point is defined by the machine learning application and is the point where the learned application identifies enough support that an event will occur to justify providing positively biased material to the customer for that life event. As such, a threshold of characteristics associated with one or more life events is identified and determined to be reached to have a confidence level for a life event occurrence. As illustrated in block 413, the process 400 may also sift false positive data points and apply those as learning data points to the learning application.

Finally, the process 400 may develop spending profiles for one or more horizon life events based on previously identified life events, as illustrated in block 415. This development is utilized in the identification process and is contributing to the learning of life event recognition of the application. In this analysis, customers in specific situation tend to purchase categories of products or shop at categories of merchants. For example, customers with children tend to purchase within specific product categories and shop at specific merchant categories. While customers without children or not expecting a child may still shop or and purchase products within those categories of products or merchants, these items may be purchased as gifts or the like. As such, in order to sift through and reduce false positives, as illustrated in block 413, and to increase certainty of a horizon life event occurring, spending profiles of a customer must be learned for different life events that provide a degree of certainty for that event.

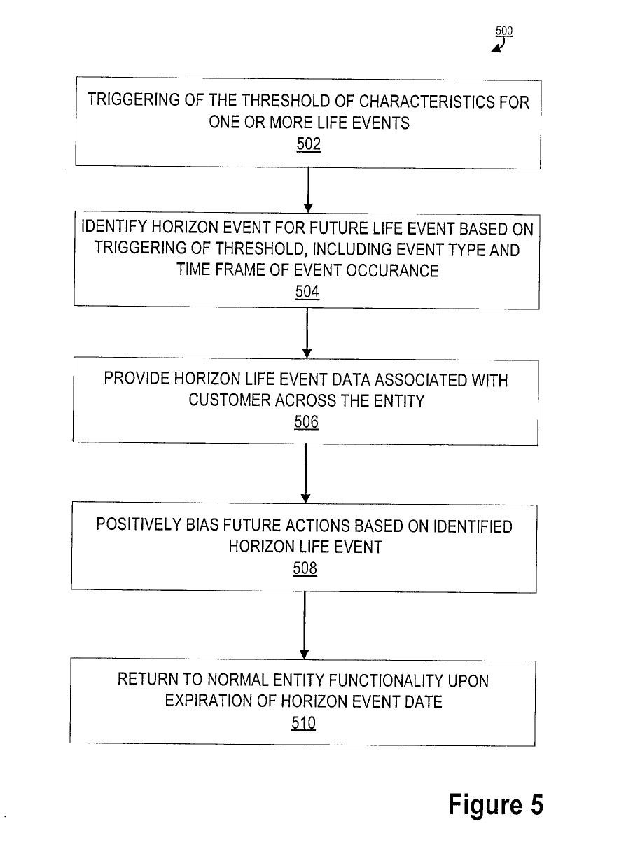

FIG. 5 illustrates a process map for life event identification and post identification processing 500, in accordance with one embodiment of the present invention. As illustrated in block 502, the process 500 is initiated by a triggering of the threshold of characteristics for one or more life events. Once the threshold is met, as illustrated in block 504, the system may identify a horizon event for the one or more life events based on triggering the threshold, where the horizon event includes the type of event and the time frame of predicted occurrence of the event.

Next, as illustrated in block 506, the system may distribute the horizon life event for the customer, across the entity. As such, the entity and all divisions associated therewith may have access to the predicted horizon life event for the customer. As illustrated in block 508, the system may positively bias future actions based on the identified horizon life event. As such, the entity may provide positively biased actions, such as providing offers, promotions, products, items, or the like. Once the entity divisions have the predicted horizon life event, the system may direct positively biased actions within the entity to the customer based on the identified life event, as illustrated in block 508.

The horizon life event has a time frame associated therewith. As such, the system may determine a projected end date to the event. For example, the system may identify the purchase of baby items and predict that the end of the event will occur when the baby is born. Furthermore, the system may continually monitor spend data of a customer past the determined event and identify shifts in transaction product categories and/or merchant categories suggesting a shift or end to a specific horizon life event. At that point, an end date to the predicted horizon life event may be determined. Once the end date is determined, the system, as illustrated in block 510, may return the entity to normal functionality upon the expiration of the horizon event date, thus no longer providing the customer with positively biased actions based on the horizon event.

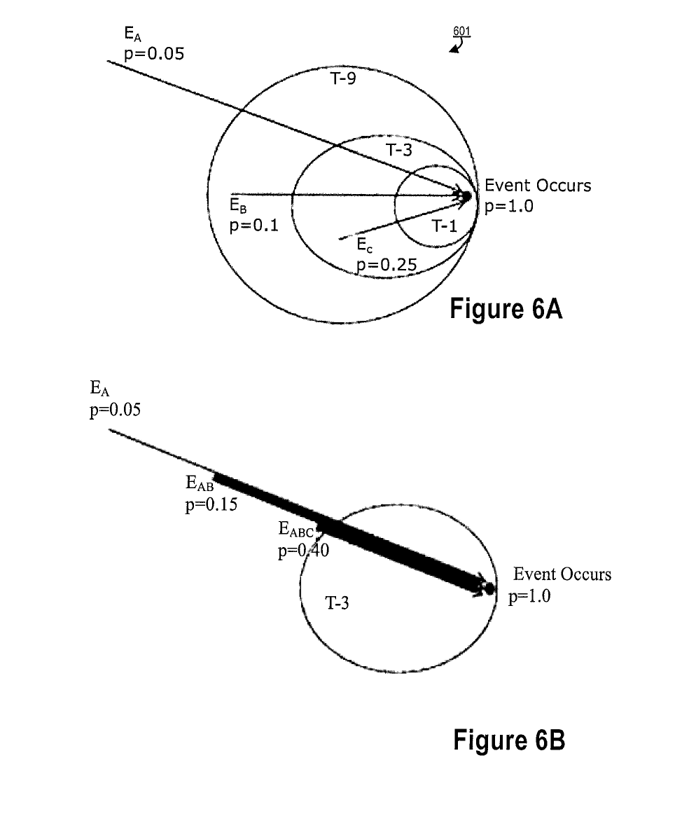

FIG. 6a and FIG. 6b illustrate graphical representations of the effect of individual supporting events and/or leading indicators on life event inference tracking as well as of triggering confidence of a horizon event occurring during life event inference tracking FIG. 6a illustrates a graph providing the effect of individual supporting events on life event inference tracking 601, in accordance with one embodiment of the present invention. The machine learning application treats the individual data points that support a particular life event as individual supporting events. These supporting events are associated with the ontology of one or more life events. As illustrated in FIG. 6a, the individual events are grouped together based on a life event that the event may be associated with. These events are then graphed on a vector space to view the events relative to the event occurrence. Each event, Ea, Eb, and Ec are also provide a p-value. The p-value is also correlates to a time frame. Each zone T-9, T-3, or T-1 represents a specific lead time to the event, in this case 9, 3, and 1 month.

FIG. 6b provides a graph illustrating triggering confidence of a horizon event occurring during life event inference tracking 602, in accordance with one embodiment of the present invention. As the collection of transaction data is evaluated against the ontology of potential life events, the sum of the probability of all transactions is computed for each known life event relationship. Each transaction and the associated products and merchant of those transactions has a contributing probability associated with it. The more there are supporting transactions that support that leading indicator occur, the more the leading indicator is bolstered and subsequently the more confident the life event may occur. At a specific point, such as a p-value being greater than a predetermined percentage, a trigger will be initiated indicating a horizon life event occurring. As illustrated in FIG. 6b, the initial leading indicator event Ea occurred. Since that time, multiple supporting transactions have occurred, such as Eb and Ec to correlate with Ea. At a specific time, T-3, the system determines a p-value that is consistent with that particular life event. As such, once the vector hits the p-value, the horizon life event is triggered. space diagram for a particular life event will trigger

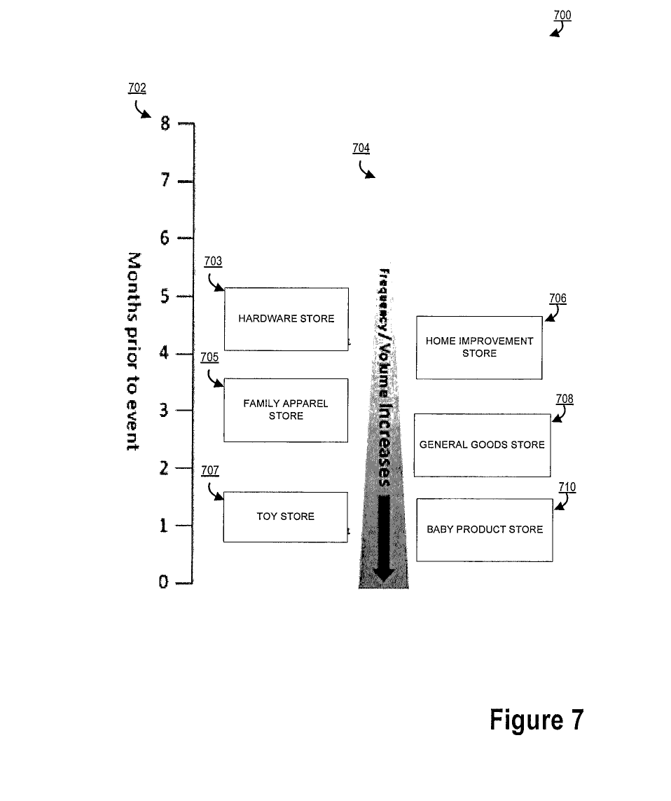

FIG. 7 provides a graph illustrating the effect of individual supporting events on frequency, magnitude, and time frame for life event inference tracking 700, in accordance with one embodiment of the present invention. In spend analysis, customers in specific situation tend to purchase categories of products or shop at categories of merchants. For example, customers with children purchase within specific product categories and shop at specific merchant categories. While customers without children or not expecting a child may still shop or and purchase products within those categories of products or merchants, these items may be purchased as gifts or the like. As such, in order to sift through and reduce false positives and to increase certainty of a horizon life event occurring, spending profiles of a customer must be learned for different life events that provide a degree of certainty for that event. As illustrated in FIG. 7 an example case of having a child is illustrated in the graph illustrating the effect of individual supporting events on frequency, magnitude, and time frame for life event inference tracking 700. This information may subsequently be utilized for development of a spend profile for the learning application. The graph illustrates a vertical axis of months prior to the life event occurring 702. At around 5-4 month prior to the event a customer may transacted at a hardware store 703 and a home improvement store 706. At around 4-2 months a customer may transact at a family apparel store 705 and a general goods store 708. Finally, at 2-1 months the customer may transact at a toy store 707 and a baby products store 710. During the time frame, it may be identified that a frequency or magnitude 704 may be increased as the time frame becomes closer to the event. This may be one example of a customer pattern prior to a life event of having a child. This pattern may be provided to the learning application as a spending profile associated with a particular life event. As such, subsequent transactions may be reviewed using this profile.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for life event inference tracking, the system comprising:
a memory device with non-transitory computer-readable program code stored thereon;
a communication device;
a communicable linkage to a distributive network of specific network data feeds;
a processing device operatively coupled to the memory device and the communication device, wherein the processing device is configured to execute the computer-readable program code to:
develop spending profiles for one or more life events based on historic data, wherein developing spending profiles include identifying a frequency and magnitude relative to a time frame for product category and merchant category transactions that provide a predictor that the one or more life events will occur;
identify customer transactions occurring within a time range that utilizes a financial institution product;
retrieve, utilizing a distributive network and the specific network data feeds, item level transaction data for products of the transactions occurring within the time range;
categorize the products of the transaction and a merchant associated with the transactions;
calculate using a learning application based on the developed spending profiles a probability of one or more potential life events occurring at a future time based on the categorized products and merchants associated with the transactions;
trigger, based on a probability value, a point of certainty that a horizon life event associated with the one or more potential life events will occur for the customer, wherein the horizon life event is a specific life event and a specific time range where the horizon life event will occur in the future;
distribute throughout an entity via the distributive network to private nodes the horizon life event for the customer;
direct positively biased actions to the customer based on the horizon life event; and
terminate the positively biased actions upon expiration of the horizon life event time range.

2. The system of claim 1, wherein item level data includes specific information identifying a product including a model number, name, and manufacturer of the product of the transaction.

3. The system of claim 1 further comprising developing and storing for future calculations of horizon life events a spending profile for the horizon life event triggered at the point of certainty that the horizon life event associated with the one or more potential life events will occur for the customer.

4. The system of claim 1, wherein the horizon life event is a specific life event determined to be within a specific time range based on life ontology, wherein the horizon life event is a major event in the customer's life that changes the customer's status or circumstance with respect to financial planning.

5. The system of claim 1, wherein positively biased actions directed to the customer include offers or promotions for products and merchant directly associated with the horizon life event.

6. The system of claim 1, wherein calculating using a learning application based on the developed spending profiles a probability of one or more potential life events occurring at a future time further comprises:
identifying leading indicators for the one or more life events, wherein the identified leading indicators are categorized products and merchants that are directly correlated with a life event; and
plotting, graphically via vector analysis, one or more categorized products and merchants associated with the transactions along with the identified leading indicators.

7. The system of claim 1, wherein calculating using a learning application further comprises sifting false positives and storing the false positives for subsequent calculations.

8. A computer program product for life event inference tracking, the computer program product comprising at least one non-transitory computer-readable medium having computer-readable program code portions embodied therein, the computer-readable program code portions comprising:
an executable portion configured for developing spending profiles for one or more life events based on historic data, wherein developing spending profiles include identifying a frequency and magnitude relative to a time frame for product category and merchant category transactions that provide a predictor that the one or more life events will occur;
an executable portion configured for identifying customer transactions occurring within a time range that utilizes a financial institution product;
an executable portion configured for retrieving, utilizing a distributive network and specific network data feeds, item level transaction data for products of the transactions occurring within the time range;
an executable portion configured for categorizing the products of the transaction and a merchant associated with the transactions;
an executable portion configured for calculating using a learning application based on the developed spending profiles a probability of one or more potential life events occurring at a future time based on the categorized products and merchants associated with the transactions;
an executable portion configured for triggering, based on a probability value, a point of certainty that a horizon life event associated with the one or more potential life events will occur for the customer, wherein the horizon life event is a specific life event and a specific time range where the horizon life event will occur in the future;
an executable portion configured for distributing throughout an entity via the distributive network to private nodes the horizon life event for the customer;
an executable portion configured for directing positively biased actions to the customer based on the horizon life event; and
an executable portion configured for terminating the positively biased actions upon expiration of the horizon life event time range.

9. The computer program product of claim 8, wherein item level data includes specific information identifying a product including a model number, name, and manufacturer of the product of the transaction.

10. The computer program product of claim 8 further comprising an executable portion configured for developing and storing for future calculations of horizon life events a spending profile for the horizon life event triggered at the point of certainty that the horizon life event associated with the one or more potential life events will occur for the customer.

11. The computer program product of claim 8, wherein the horizon life event is a specific life event determined to be within a specific time range based on life ontology, wherein the horizon life event is a major event in the customer's life that changes the customer's status or circumstance with respect to financial planning.

12. The computer program product of claim 8, wherein positively biased actions directed to the customer include offers or promotions for products and merchant directly associated with the horizon life event.

13. The computer program product of claim 8, wherein calculating using a learning application based on the developed spending profiles a probability of one or more potential life events occurring at a future time further comprises:
identifying leading indicators for the one or more life events, wherein the identified leading indicators are categorized products and merchants that are directly correlated with a life event; and
plotting, graphically via vector analysis, one or more categorized products and merchants associated with the transactions along with the identified leading indicators.

14. The computer program product of claim 8, wherein calculating using a learning application further comprises sifting false positives and storing the false positives for subsequent calculations.

15. A computer-implemented method for life event inference tracking, the method comprising:
providing a computing system comprising a computer processing device, a non-transitory computer readable medium, and a communicable linkage to a distributive network of specific network data feeds, where the computer readable medium comprises configured computer program instruction code, such that when said instruction code is operated by said computer processing device, said computer processing device performs the following operations:
developing spending profiles for one or more life events based on historic data, wherein developing spending profiles include identifying a frequency and magnitude relative to a time frame for product category and merchant category transactions that provide a predictor that the one or more life events will occur;
identifying customer transactions occurring within a time range that utilizes a financial institution product;
retrieving, utilizing a distributive network and the specific network data feeds, item level transaction data for products of the transactions occurring within the time range;
categorizing the products of the transaction and a merchant associated with the transactions;
calculating using a learning application based on the developed spending profiles a probability of one or more potential life events occurring at a future time based on the categorized products and merchants associated with the transactions;
triggering, based on a probability value, a point of certainty that a horizon life event associated with the one or more potential life events will occur for the customer, wherein the horizon life event is a specific life event and a specific time range where the horizon life event will occur in the future;
distributing throughout an entity via the distributive network to private nodes the horizon life event for the customer;
directing positively biased actions to the customer based on the horizon life event; and
terminating the positively biased actions upon expiration of the horizon life event time range.

16. The computer-implemented method of claim 15, wherein item level data includes specific information identifying a product including a model number, name, and manufacturer of the product of the transaction.

17. The computer-implemented method of claim 15 further comprising developing and storing for future calculations of horizon life events a spending profile for the horizon life event triggered at the point of certainty that the horizon life event associated with the one or more potential life events will occur for the customer.

18. The computer-implemented method of claim 15, wherein the horizon life event is a specific life event determined to be within a specific time range based on life ontology, wherein the horizon life event is a major event in the customer's life that changes the customer's status or circumstance with respect to financial planning.

19. The computer-implemented method of claim 15, wherein calculating using a learning application based on the developed spending profiles a probability of one or more potential life events occurring at a future time further comprises:
identifying leading indicators for the one or more life events, wherein the identified leading indicators are categorized products and merchants that are directly correlated with a life event; and
plotting, graphically via vector analysis, one or more categorized products and merchants associated with the transactions along with the identified leading indicators.

20. The computer-implemented method of claim 15, wherein calculating using a learning application further comprises sifting false positives and storing the false positives for subsequent calculations.
